(19) United States
(12) Patent Application Publication
(10) Pub. No.: US 2026/0371268 A1
(43) Pub. Date: Nov. 19, 2026

(54) SYNCHRONIZATION METHOD FOR IOT COMMUNICATION AND RELATED APPARATUS

(71) Applicant: GUANGDONG OPPO MOBILE TELECOMMUNICATIONS CORP., LTD., Dongguan (CN)

(72) Inventor: Huei-Ming LIN, Taipei (CN)

(21) Appl. No.: 19/736,107

(22) Filed: Jul. 9, 2026

Related U.S. Application Data
(63) Continuation of application No. PCT/CN2025/076105, filed on Feb. 7, 2025.
(60) Provisional application No. 63/555,272, filed on Feb. 19, 2024.

(51) Int. Cl. H04W 56/00

(52) U.S. Cl. CPC H04W 56/0015

(57) ABSTRACT

A synchronization method for Internet of Things (IoT) communication performed by a base station includes transmitting at least one of a synchronization signal (SS) and a preamble to be used by an IoT device for clock timing synchronization and receiving an IoT downlink (DL) communication, where the SS is transmitted periodically with a time interval or the SS is transmitted one or multiple times within a time window, and the preamble with a sequence pattern is transmitted prior to a DL transmission.

### CROSS-REFERENCE TO RELATED APPLICATION

The application is a Continuation Application of PCT/CN2025/076105 filed Feb. 7, 2025, which claims priority to U.S. Provisional Patent Application No. 63/555,272 filed on Feb. 19, 2024, which are incorporated herein by reference in their entirety.

### BACKGROUND OF DISCLOSURE

### 1. Field of the Disclosure

The present disclosure relates to the field of communication systems, and more particularly, to a synchronization method for Internet of Things (IoT) communication, a base station, an IoT device, and a related apparatus, which can provide a good communication performance and/or provide high reliability.

### 2. Description of the Related Art

In the past two decades, wireless communication for interconnecting millions or even billions of small and low power consumption devices or things with reduced capability to create “Internet of Things” (IoT) has attracted much attention and development in communication standard forums and deployment across various industries. When many of these IoT devices are interconnected to a network, which could be a local area private network for inventory in a warehouse or a wide area public network for transportation within/across cities, it can greatly improve productivity efficiency in an organization and increase comforts of life at home. Today a very commonly used IoT technology is Radio Frequency IDentification (RFID), which typical consists of a reader and tags attached to objects. RFID tags are used in many areas, such as tracking production progress through the assembly line, identifying objects/containers in warehouses and logistics, charging road tolls from vehicles using eTags, authenticating passengers using ePassport in airports, etc.

### SUMMARY

In a first aspect of the present disclosure, a synchronization method for Internet of Things (IoT) communication performed by a base station includes transmitting at least one of a synchronization signal (SS) and a preamble to be used by an IoT device for clock timing synchronization and receiving an IoT downlink (DL) communication, wherein the SS is transmitted periodically with a time interval or the SS is transmitted one or multiple times within a time window, and the preamble with a sequence pattern is transmitted prior to a DL transmission.

In a second aspect of the present disclosure, a synchronization method for Internet of Things (IoT) communication performed by a base station includes providing a trigger or an indication to a carrier wave node (CWN) to transmit a carrier wave in an IoT uplink (UL) frequency channel, wherein timing to transmitting the carrier wave from the CWN is earlier than a scheduled UL transmission for an IoT device.

In a third aspect of the present disclosure, a synchronization method for Internet of Things (IoT) communication performed by an IoT device includes receiving at least one of a synchronization signal (SS) and a preamble for clock timing synchronization and receiving an IoT downlink (DL) communication, wherein the SS is transmitted periodically with a time interval or the SS is transmitted one or multiple times within a time window, and the preamble with a sequence pattern is transmitted prior to a DL transmission.

In a fourth aspect of the present disclosure, a synchronization method for Internet of Things (IoT) communication performed by an IoT device, includes receiving a carrier wave transmitted from a carrier wave node (CWN) before a scheduled UL transmission of the IoT device, wherein the carrier wave is transmitted by the CWN in an IoT uplink (UL) frequency channel through a trigger or an indication transmitted from the base station to the CWN.

In a fifth aspect of the present disclosure, a base station includes a memory, a transceiver, and a processor coupled to the memory and the transceiver. The base station is configured to perform the above method.

In a sixth aspect of the present disclosure, an Internet of Things (IoT) device includes a memory, a transceiver, and a processor coupled to the memory and the transceiver. The IoT device is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a non-transitory computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures may be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating a first Ambient-IoT (A-IoT) communication topology according to an embodiment of the present disclosure.

FIG. 2 is a schematic diagram illustrating a second A-IoT communication topology according to an embodiment of the present disclosure.

FIG. 3 is a block diagram of a base station, an IoT device, and a carrier wave node (CWN) of communication in a communication network system according to an embodiment of the present disclosure.

FIG. 4 is a flowchart illustrating a synchronization method for Internet of Things (IoT) communication performed by a base station according to an embodiment of the present disclosure.

FIG. 5 is a flowchart illustrating a synchronization method for Internet of Things (IoT) communication performed by a base station according to an embodiment of the present disclosure.

FIG. 6 is a flowchart illustrating a synchronization method for IoT communication performed by an IoT device according to an embodiment of the present disclosure.

FIG. 7 is a flowchart illustrating a synchronization method for IoT communication performed by an IoT device according to an embodiment of the present disclosure.

FIG. 8 is a schematic diagram illustrating an exemplary illustration of proposed synchronization signals transmission scheme for IoT downlink (DL) communication in Topology 1 according to an embodiment of the present disclosure.

FIG. 9 is a schematic diagram illustrating an exemplary illustration of proposed synchronization signals transmission scheme for IoT uplink (UL) communication in Topology 1 according to an embodiment of the present disclosure.

FIG. 10 is a block diagram of an example of a computing device according to an embodiment of the present disclosure.

FIG. 11 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technology of RFID is primarily used for identification of objects, assets, people or animals from emitting a tag ID, the reading range is limited to just a few meters and it requires handheld scanning which leads to labor intensive and time-consuming operations or costly deployments of RFID portals/gates. Other IoT technologies include NarrowBand-IoT (NB-IoT) and massive Machine Type Communication (mMTC) developed by 3rd generation partnership project (3GPP), which can provide much higher data rates and communication range/coverage, but at a cost of higher power consumption and implementation complexity. In turn, this translates into a higher device price and requires a battery to operate that needs to be replaced or recharged manually, which leads to high maintenance cost, serious environmental issues, and even safety hazards for some use cases.

Therefore, there is a need for a synchronization method for Internet of Things (IoT) communication, a base station, an IoT device, and a related apparatus, which can solve issues in the prior art and other issues.

There is a need for a new form/type of IoT devices, the new form/type of IoT devices can be densely deployed (e.g., 150 devices per 100 m²) and still manageable by a network communication node. The new form/type of IoT devices supports a communication range of 10-50 m, a maximum data rate of 5 kpbs to convey tag ID, user, sensor and/or location/positioning information, a latency target between 1-10 seconds, infrequent transmissions (once in an hour/day/week), and a positioning accuracy of 1-3 meters for indoor and several tends of meters for outdoor.

Additionally, the new form/type of IoT devices, once deployed, may be able to operate for a very long period of time without the need of a battery (e.g., for years), such that the maintenance and operation costs are minimized, the form factor of a device can be small for easy application (e.g., sticker type of tags) and the device is safe to operate everywhere. As such, this gives rise to ambient powered IoT devices, where the device without any battery is powered purely by radio energy transmitted by a data communication triggering node (e.g., base station (BS), user equipment (UE)) or an external carrier wave node. But an Ambient-IoT (A-IoT) device may be equipped with a storage for energy harvested from radio waves for data processing and radio transmission at a later time.

As observed from the above operation requirements (coverage, data type and data rate, latency, transmission frequency and positioning), which are higher than RFID, the intended use cases for A-IoT devices include: 1. Indoor inventory: automated warehousing, medical instruments inventory management and positioning, non-public network for logistics, automobile manufacturing, airport terminal/shipping port, smart homes, automated supply chain distribution, fresh food supply chain, end-to-end logistics, electronic shelf label. 2. Indoor command: online modification of medical instruments status, device activation and deactivation, elderly health care, device permanent deactivation.

### Types of A-Iot Devices/Tags

Considering the limited size and complexity required by practical applications for battery less A-IoT devices with no energy storage capability or A-IoT devices with limited energy storage that do not need to be replaced or recharged manually, the output power of energy storage unit is typically from a few μW to a few hundreds of μW. In general, it is expected that A-IoT devices are categorized into the following types.
1. Lower peak power consumption A-IoT devices/tags (a few μW) are equipped with energy storage, neither downlink (DL) nor uplink (UL) amplification in the device. Device's UL transmission is backscattered on a carrier wave provided externally.
2. Higher peak power consumption A-IoT devices/tags (a few hundreds of μW) has energy storage, both DL and/or UL amplification in the device. The device's UL transmission may be generated internally by the device, or be backscattered on a carrier wave provided externally.

### A-Iot Communication Topologies

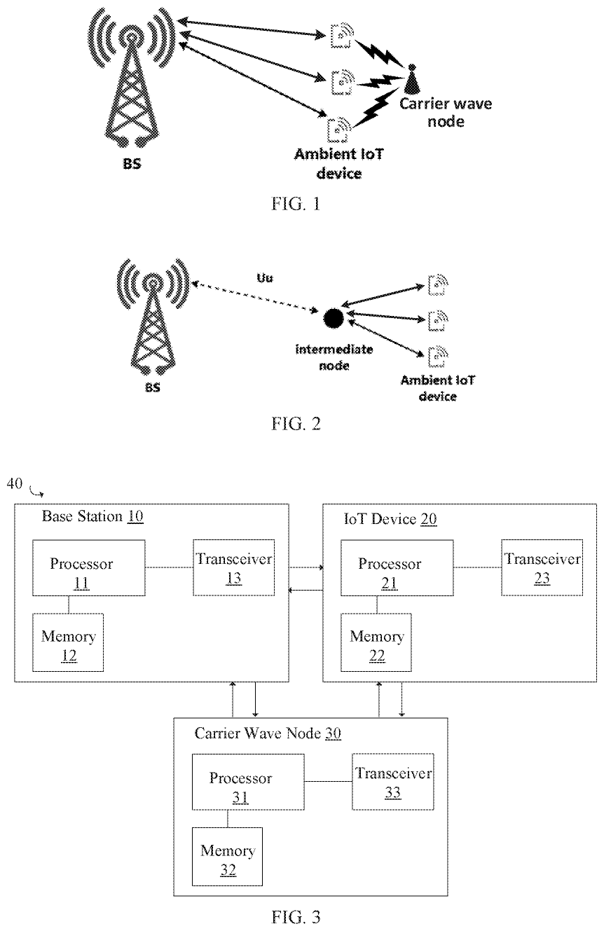

FIG. 1 illustrates a first Ambient-IoT (A-IoT) communication topology according to an embodiment of the present disclosure. That is topology 1: Direct data and signaling communication between BS and A-IoT devices. FIG. 2 illustrates a second Ambient-IoT (A-IoT) communication topology according to an embodiment of the present disclosure. That is topology 2: Data and signaling communication between BS and A-IoT devices via an intermediate node. Different from RFID devices, where a handheld reader or an expensive RFID portal/gate is used to obtain ID information from the tags, A-IoT devices are expected to exchange data and signaling information with a base station (BS) directly or via an intermediate node acting like an information relay/transfer point as shown by the above Topology 1 and Topology 2 illustrations.

In Topology 1 (direct communication between BS and A-IoT), A-IoT devices/tags directly communicates in both directions (DL and UL) with a BS. The communication between the BS and A-IoT devices/tags includes data information (e.g., tag IDs, sensor information, positioning, etc.) and signaling information (paging, random access, configuration details, scheduling information, etc.) The carrier wave node has two main functions in Topology 1; one it provides to A-IoT devices additional energy that is needed for processing DL information from the BS and performing UL transmission to the BS when the separation distance is far (i.e., pathloss is high); second it provides a UL carrier wave on which A-IoT devices perform backscattering transmission to resolve a full-duplex and a spectrum usage regulation issue when a Frequency Division Duplexing (FDD) spectrum band is used for A-IoT operation. Since the BS directly communicates with A-IoT devices/tags to exchange commands and data information, it is also commonly referred to as the ‘reader’in A-IoT communication.

In Topology 2 (indirect communication between the base station (BS) and A-IoT devices via an intermediate node), the intermediate node (which could be a user equipment (UE) or a repeater) under the BS's control relays or transfers data and signaling information between the BS and the A-IoT devices. The intermediate node UE communicates directly with the BS and relays information from the A-IoT devices to the BS over the existing cellular Uu interface for both downlink (DL) and uplink (UL). For simplicity, this bidirectional communication between the BS and the intermediate node is referred to as “intermediate UE DL and UL” or “Uu DL and UL.” The intermediate node UE also communicates directly with the A-IoT devices, relaying information from the BS to the A-IoT devices. For simplicity, this bidirectional communication is referred to as “A-IoT device DL and UL.” In Topology 2, A-IoT devices harvest radio energy transmitted from the intermediate node UE to power data/signaling processing and A-IoT device UL transmissions. When an FDD spectrum band is used for A-IoT operation, both A-IoT device DL and UL transmissions are expected to occur on an uplink frequency carrier. Topology 2 is typically used in scenarios where the base station (BS) is located outdoors, and A-IoT devices are located indoors. In this setup, an intermediate UE facilitates communication between the BS and the A-IoT devices.

As seen in both Topology 1 and Topology 2, there is only one central communication node (i.e., a ‘reader’) that exchange commands and data information directly with A-IoT devices/tags, for simplicity, let's refer this bidirectional communication between the reader and A-IoT devices/tags as “reader-to-device” (R2D) and “device-to-reader” (D2R) communications. And let's further define the communication channel in the physical layer for transmitting command, control and data information in R2D communication as “physical reader device channel” (PRDCH) and the communication channel in the physical layer for transmitting response, control and data information in D2R communication as “physical device reader channel” (PDRCH).

Downlink and uplink resource allocation and scheduling in cellular communication:

In cellular communication, when a user equipment (UE) is in the radio resource control (RRC) connected state with a serving base station (BS), such as a 5th Generation (5G) New Radio (NR) gNB, the allocation of resource blocks (RBs) and timings (i.e., symbols and slots) for downlink (DL) transmissions (gNB transmitting and UE receiving) and uplink (UL) transmissions (UE transmitting and gNB receiving) to/from one or multiple UEs in a cell is fully managed and controlled by the serving gNB.

For resource allocation and scheduling in cellular DL over the Uu interface, the process is simpler than cellular UL where it does not require UE to send a scheduling request and a buffer status report (BSR). In both cellular DL and cellular UL, dynamic scheduling and configured scheduling modes are supported.

In cellular DL, dynamic scheduling mode is the mechanism in which gNB schedules each and every time and frequency resource for physical downlink shared channel (PDSCH) transmission to a UE via downlink control information (DCI) carried in physical downlink control channel (PDCCH). In configured scheduling mode, which is called semi-persistent scheduling (SPS) for cellular DL, gNB configures a set of time and frequency resources and parameters necessary for PDSCH scheduling using RRC (RRC setup or RRC reconfiguration), and sends a DCI to activate SPS transmissions in the DL. As such, gNB schedules PDSCH without using DCI for every transmission to greatly reduce the load of physical (PHY) and medium access control (MAC) scheduling.

In cellular UL, dynamic scheduling mode operates in the same manner as cellular DL, except that UE needs to firstly send scheduling request (SR) and buffer status report (BSR) to gNB to request resource(s) for physical uplink shared channel (PUSCH) transmission. The gNB then schedules each and every UL transmission in PUSCH via DCI. In configured scheduling mode, which is called configured grant (CG) for cellular UL, two different types of mechanism called Type 1 and Type 2 are supported in 5G-NR.
1. Type 1 CG: gNB configures using RRC a set of time and frequency resources and parameters necessary for PUSCH transmissions, and UE is expected to transmit PUSCH without any DCI trigger/indication.
2. Type 2 CG: gNB firstly configures using RRC a set of time and frequency resources and parameters necessary for PUSCH transmissions. When gNB schedules/grants UE to transmit PUSCH using Type 2 CG resources, it sends an activation command in DCI; otherwise, it sends a deactivation DCI to stop PUSCH transmission.

### Synchronization in Cellular Communication

In cellular communication, it is essential for UEs (e.g., a smartphone UE after power on or moving from one cell to another) to perform cell selection and re-selection procedures to constantly search for a “best cell” to camp on or to be connected with in order to have a best available link quality and service. To achieve this, a UE can first identify all detectable cells (e.g., 3G, 4G, 5G, etc.), determine which cells are accessible (as some cells may be barred from access and some may belong to a different cellular network operator) and measure which cell provides the best signal strength (among the ones that are accessible to the UE). Once this process is completed, the UE makes a connection to the network (e.g., a gNB) and reports its measurements to finalize the cell camping or cell handover procedure. As described, this entire process includes cell searching and communication with a gNB. To provide all these functionalities to the UE in a cellular communication system, synchronization signals and essential system information are constantly and periodically broadcasted by a cell's BS.

The synchronization signals transmitted by the BS primarily serve a few essential functions in a 5G cellular system, including at least one of the followings.
1. Enable UE identification of a radio carrier frequency within a spectrum band and maintaining UE's frequency synchronization to the cell's radio carrier.
2. Provide a reference point in time for which UEs are able to determine and derive radio communication frame, subframe and slot boundaries (time synchronization).
3. Support beam sweeping and beam management operation when UE reports a best synchronization signal block index.

In a frequency division duplex (FDD) spectrum band, the communication between BS and UEs in a cell is carried out over a pair of a DL and a UL frequency carrier. Due to spectrum regulations, the BS transmits (UE receive) all signals and channels only in the DL carrier, and UEs transmit (BS receive) in the UL carrier. As such, all UEs in a cell need to firstly monitor and detect synchronization signals transmitted from the BS to achieve both frequency and time synchronization to the cell's DL carrier. Then based on a pre-defined frequency separation between DL and UL frequency carriers in a FDD band, a UE derives the exact frequency for the UL carrier of the cell, tunes its radio frequency (RF) oscillator to the desired/derived frequency, and transmits in the UL carrier at a radio frame and slot timing that are aligned with the DL carrier. In a time division duplex (TDD) spectrum band, on the other hand, DL (BS transmit) and UL (UE transmit) communication between the BS and UEs in a cell is performed on a same frequency carrier but separated in different time instances (i.e., subframes or slots) to avoid a full duplexer issue. Since the same carrier frequency is used in both DL and UL, the synchronization signals transmitted in the DL is directly used by UEs in setting the UL carrier frequency. Thus, no frequency tuning or retuning is required in the UE RF oscillator to perform UL transmissions. As seen, in both FDD and TDD cellular systems, the carrier frequency and timing in which the UE performs its UL transmissions are fully relied and derived base on the DL synchronization signals transmitted from the cell's BS. Due to mobility of UEs moving across different cells, new UEs could power-on at any time in a cell, and existing idle and connected UEs need to constantly monitor and measure signal strength of neighbor cells all the time, the synchronization signals are always and constantly transmitted by the BS to support these functions.

In some embodiments of the present disclosure, downlink and uplink synchronization methods for an IoT device/tag to communicate with a BS in a cellular system are disclosed. Some embodiments propose that the methods for synchronization in both the frequency and the time domains to a downlink and uplink carrier is separated and operated independently from each other to resolve an inaccurate DL to UL frequency conversion issue and a sampling frequency offset/error issue. Furthermore, the method for frequency and time synchronization to a DL carrier involves at least two stages, where an early stage is for an initial/coarse DL synchronization based on periodic synchronization signals and a later stage is for synchronization fine-tuning based on a burst of DL synchronization signals or a DL preamble sequence transmitted by the BS just before the delivery of data and signaling information in a DL carrier. The method for IoT UL synchronization involves the BS triggering a carrier wave node (CWN) to transmit a carrier wave/waveform to the IoT device/tag, where the carrier wave/waveform and its transmission start time are used as the basis for the UL frequency and time synchronization for the IoT device/tag.

Other benefits from adopting the proposed frequency and time synchronization methods for IoT device/tag in DL and UL communication of a cellular system may further include at least one of followings.
1. Accurate and direct synchronization to a DL and UL frequency carriers even for a low-complexity and low-cost IoT device/tag receiver design.
2. Fast energy charging and power-ON IoT devices/tags only at the timing when the BS needs to transmit data and signaling information in the DL or when a IoT device/tag needs to perform UL transmission to the BS. Hence the proposed synchronization methods provide a resource and power efficient operation.

FIG. 3 illustrates that, in some embodiments, a base station 10 (such as an IoT reader), an IoT device 20, and a carrier wave node (CWN) 30 of communication in a communication network system 40 according to an embodiment of the present disclosure are provided. The communication network system 40 includes the base station 10, the IoT device 20, and the CWN 30. The base station 10 may include a memory 12, a transceiver 13, and a processor 11 coupled to the memory 12 and the transceiver 13. The IoT device 20 may include a memory 22, a transceiver 23, and a processor 21 coupled to the memory 22 and the transceiver 23. The CWN 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31 and transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the transceiver 13 is configured to transmit at least one of a synchronization signal (SS) and a preamble to be used by the IoT device 20 for clock timing synchronization and receive an IoT downlink (DL) communication, wherein the SS is transmitted periodically with a time interval or the SS is transmitted one or multiple times within a time window, and the preamble with a sequence pattern is transmitted prior to a DL transmission. This can solve issues in the prior art and other issues and/or improve communication performance and reliability.

In some embodiments, the transceiver 13 is configured to provide a trigger or an indication to the CWN 30 to transmit a carrier wave in an IoT uplink (UL) frequency channel, wherein timing to transmitting the carrier wave from the CWN 30 is earlier than a scheduled UL transmission for the IoT device 20. This can solve issues in the prior art and other issues and/or improve communication performance and reliability.

In some embodiments, the transceiver 23 is configured to receive at least one of a synchronization signal (SS) and a preamble for clock timing synchronization and receive an IoT downlink (DL) communication, wherein the SS is transmitted periodically with a time interval or the SS is transmitted one or multiple times within a time window, and the preamble with a sequence pattern is transmitted prior to a DL transmission. This can solve issues in the prior art and other issues and/or improve communication performance and reliability.

In some embodiments, the transceiver 23 is configured to receive a carrier wave transmitted from the CWN 30 before a scheduled UL transmission of the IoT device 20, wherein the carrier wave is transmitted by the CWN 30 in an IoT uplink (UL) frequency channel through a trigger or an indication transmitted from the base station 10 to the CWN 30. This can solve issues in the prior art and other issues and/or improve communication performance and reliability.

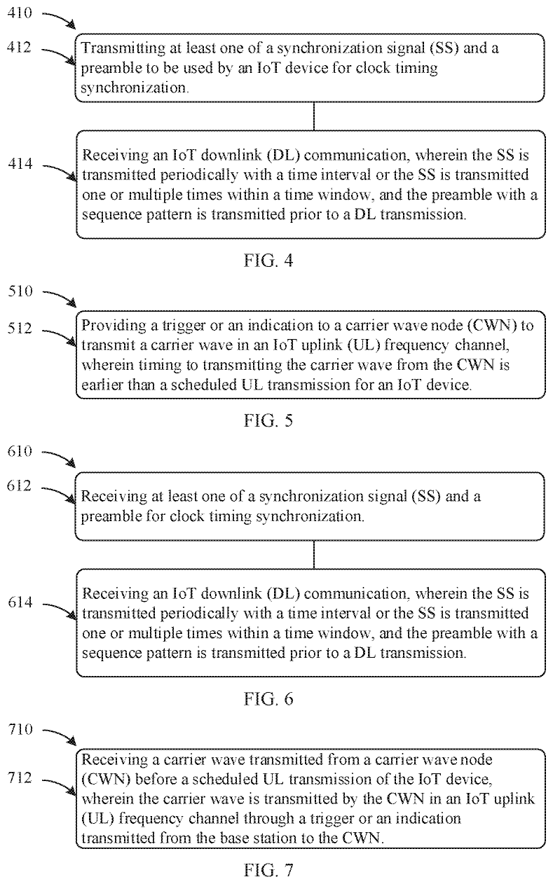

FIG. 4 illustrates a synchronization method 410 for Internet of Things (IoT) communication performed by a base station according to an embodiment of the present disclosure. In some embodiments, the method 410 includes: an operation 412, transmitting at least one of a synchronization signal (SS) and a preamble to be used by an IoT device for clock timing synchronization, and an operation 414, receiving an IoT downlink (DL) communication, wherein the SS is transmitted periodically with a time interval or the SS is transmitted one or multiple times within a time window, and the preamble with a sequence pattern is transmitted prior to a DL transmission. This can solve issues in the prior art and other issues and/or improve communication performance and reliability.

In some embodiments, the time interval is pre-defined or pre-configured. In some embodiments, the time window is pre-defined or pre-configured. In some embodiments, the sequence pattern is a fixed or pre-defined sequence pattern. In some embodiments, the method further includes transmitting the at least one of the SS and the preamble periodically in a DL carrier prior to the DL transmission. In some embodiments, the at least one of the SS and the preamble is transmitted in a frequency location with a bandwidth (BW) that covers an entire bandwidth part (BWP) of a DL carrier allocated for IoT communication. In some embodiments, the at least one of the SS and the preamble is transmitted in a frequency location with a bandwidth (BW) within a BWP allocated for IoT DL communication. In some embodiments, a frequency offset value is pre-defined or indicated to the IoT device. In some embodiments, the at least one of the SS and the preamble is transmitted in the same IoT channel where the DL transmission is to be transmitted from the base station.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices. The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, a relevant protocol applied in the future communication system, which is not limited in the present disclosure.

FIG. 5 illustrates a synchronization method 510 for Internet of Things (IoT) communication performed by a base station according to an embodiment of the present disclosure. In some embodiments, the method 510 includes: an operation 512, providing a trigger or an indication to a carrier wave node (CWN) to transmit a carrier wave in an IoT uplink (UL) frequency channel, wherein timing to transmitting the carrier wave from the CWN is earlier than a scheduled UL transmission for an IoT device. This can solve issues in the prior art and other issues and/or improve communication performance and reliability.

In some embodiments, providing the trigger or the indication to the CWN to transmit the carrier wave in the IoT UL frequency channel is based on at least one of following mechanisms: wherein in a first mechanism, the base station determines that the CWN reads from a UL scheduling information provided to the IoT device, acquires an exact UL frequency channel and timing from which the IoT device needs to perform an UL transmission, and transmits the carrier wave that includes at least a scheduled UL frequency channel and covers at least a duration of the UL transmission, wherein in a second mechanism, the base station directly triggers the CWN by indicating the exact UL frequency channel and timing to transmit one or more carrier waves. In some embodiments, the trigger or the indication is transmitted from the base station to the CWN through a downlink control information (DCI), and the DCI includes one or more UL frequency channels, and/or a start timing and transmission duration of the carrier wave. In some embodiments, in the first mechanism, the base station determines that: the CWN determines a start timing for a carrier wave transmission that is earlier than a scheduled IoT UL transmission based on a timing offset. In some embodiments, the timing offset has a fixed, pre-defined or configured value. In some embodiments, in the second mechanism, the timing to transmit the one or more carrier waves indicated by the base station includes a starting timing for a carrier wave transmission and a timing offset for the carrier wave transmission.

FIG. 6 illustrates a synchronization method 610 for Internet of Things (IoT) communication performed by an IoT device according to an embodiment of the present disclosure. In some embodiments, the method 610 includes: an operation 612, receiving at least one of a synchronization signal (SS) and a preamble for clock timing synchronization, and an operation 614, receiving an IoT downlink (DL) communication, wherein the SS is transmitted periodically with a time interval or the SS is transmitted one or multiple times within a time window, and the preamble with a sequence pattern is transmitted prior to a DL transmission. This can solve issues in the prior art and other issues and/or improve communication performance and reliability.

In some embodiments, the time interval is pre-defined or pre-configured. In some embodiments, the time window is pre-defined or pre-configured. In some embodiments, the sequence pattern is a fixed or pre-defined sequence pattern. In some embodiments, the method further includes receiving the at least one of the SS and the preamble periodically in a DL carrier prior to the DL transmission. In some embodiments, the at least one of the SS and the preamble is transmitted in a frequency location with a bandwidth (BW) that covers an entire bandwidth part (BWP) of a DL carrier allocated for IoT communication. In some embodiments, the at least one of the SS and the preamble is transmitted in a frequency location with a bandwidth (BW) within a BWP allocated for IoT DL communication. In some embodiments, a frequency offset value is pre-defined or indicated to the IoT device. In some embodiments, the at least one of the SS and the preamble is transmitted in the same IoT channel where the DL transmission is to be transmitted from the base station.

FIG. 7 illustrates a synchronization method 710 for Internet of Things (IoT) communication performed by an IoT device according to an embodiment of the present disclosure. In some embodiments, the method 710 includes: an operation 712, receiving a carrier wave transmitted from a carrier wave node (CWN) before a scheduled UL transmission of the IoT device, wherein the carrier wave is transmitted by the CWN in an IoT uplink (UL) frequency channel through a trigger or an indication transmitted from the base station to the CWN. This can solve issues in the prior art and other issues and/or improve communication performance and reliability.

In some embodiments, the trigger or the indication is based on at least one of following mechanisms: wherein in a first mechanism, the IoT device determines that the CWN reads from a UL scheduling information provided to the IoT device, acquires an exact UL frequency channel and timing from which the IoT device needs to perform an UL transmission, and transmits the carrier wave that includes at least a scheduled UL frequency channel and covers at least a duration of the UL transmission, wherein in a second mechanism, the IoT device determines that the base station directly triggers the CWN by indicating the exact UL frequency channel and timing to transmit one or more carrier waves. In some embodiments, the trigger or the indication is transmitted from the base station to the CWN through a downlink control information (DCI), and the DCI includes one or more UL frequency channels, and/or a start timing and transmission duration of the carrier wave. In some embodiments, in the first mechanism, the IoT device determines that: the CWN determines a start timing for a carrier wave transmission that is earlier than a scheduled IoT UL transmission based on a timing offset. In some embodiments, the timing offset has a fixed, pre-defined or configured value. In some embodiments, in the second mechanism, the timing to transmit the one or more carrier waves indicated by the base station includes a starting timing for a carrier wave transmission and a timing offset for the carrier wave transmission. In some embodiments, when the IoT device is a passive type of IoT device, by receiving the carrier wave transmitted from the CWN before the scheduled UL transmission of the IoT device, the passive type of IoT device modulates a data information on to the carrier wave and performs backscattering transmission at a timing scheduled by the base station. In some embodiments, when the IoT device is an active type of IoT device, by receiving the carrier wave transmitted from the CWN before the scheduled UL transmission of the IoT device, the active type of IoT device generate a UL carrier for the IoT UL communication according to a frequency channel in which the carrier wave is received.

### EXAMPLES

To enable and support cellular wireless communication between a base station (BS) and ambient-powered Internet of Things (IoT) devices/tags within a cell, it is essential for IoT devices/tags to be synchronized with the BS in both the frequency and time domains. This synchronization ensures that they communicate on the same carrier frequency(ies), transmit and receive at the correct timings, deliver data and signaling messages efficiently, minimize mutual interference among IoT devices/tags, and prevent disruptions to the normal cellular operation of the BS, user equipment (UEs), and neighboring cells.

In conventional cellular communication, frequency and time synchronization between the BS and normal UEs is achieved through the BS transmitting synchronization signals (SS) solely on the downlink (DL) frequency carrier. However, IoT devices/tags, which operate without a battery and use low-complexity frequency oscillators, lack the stability of crystal oscillators. As a result, their frequency conversion from receiving SS in the DL carrier to transmitting signals in the uplink (UL) carrier tends to be inaccurate and unreliable.

Given that the channel bandwidth (BW) for low-data-rate IoT communication in both DL and UL directions is expected to be only around 180 kHz, a frequency conversion error of a few hundred kHz could lead to complete misdetection of UL transmissions by the BS. Moreover, such errors may cause undesirable interference with neighboring carriers or cells. Therefore, a more reliable and accurate frequency synchronization mechanism is necessary to support IoT communication in a cellular environment.

Moreover, the data and signaling exchange between the BS and an IoT device/tag within a cell is expected to be highly infrequent—occurring only once every few hours or even days for control information, device/tag identification, or sensor data transmission. Since the BS does not need to track or support the mobility of IoT devices/tags during communication, these devices/tags will remain in a power-OFF state most of the time.

On one hand, continuously transmitting and broadcasting SS, as in conventional cellular communication, appears unnecessary for IoT communication. It would lead to excessive power consumption, increased costs, environmental concerns, and inefficient resource utilization. On the other hand, a battery-less IoT device/tag must first harvest energy to power its RF receiver and transmitter circuits, though some energy storage capacity may be available. If the BS transmits SS only during active communication, it may not provide sufficient energy for the IoT device/tag to operate effectively. Therefore, a solution is required to wirelessly supply energy to IoT devices/tags, enabling them to detect SS, achieve frequency and timing synchronization, and facilitate both downlink reception and uplink transmission.

In Topology 1 of IoT communication, data and signaling exchange between a cell's BS and an IoT device/tag in the downlink (DL) direction occurs directly, without routing through or being relayed by an intermediate node (unlike Topology 2). To ensure reliable communication, the IoT device/tag may achieve precise frequency and frame/slot timing synchronization with the BS's DL carrier, particularly since the BS may transmit data and control signals at any time. Therefore, for fast and accurate frequency and time synchronization at the IoT device/tag, the BS can transmit synchronization signals directly in the DL.

On the other hand, uplink (UL) transmissions from an IoT device/tag follow a different traffic pattern and operate on a separate carrier frequency from downlink (DL) communication. As previously discussed, UL transmissions in IoT communication are triggered and reactive, meaning an IoT device/tag does not independently initiate data transmission to the BS. Instead, it only responds when receiving specific inventory or query requests from the BS (e.g., requests for device/tag ID, sensor data, or location information). If an IoT device/tag meets the query criteria, it transmits the requested information in the UL.

In contrast, for command/instruction-based communication from the BS (e.g., turning off a device/tag or deactivating a function), no response is required, and thus, no UL transmission occurs. This means that not every IoT DL transmission from the BS will trigger a corresponding UL transmission, allowing IoT devices/tags to conserve energy by avoiding unnecessary UL synchronization.

Furthermore, due to frequency conversion errors, IoT devices/tags struggle to accurately tune their RF oscillator for UL transmissions using synchronization signals (SS) received on the DL carrier. In higher peak power consumption IoT devices/tags, this inaccuracy can lead to significant transmission errors, while in lower peak power consumption devices/tags utilizing backscattering for UL transmission, the timing of the received carrier waveform heavily influences synchronization. Therefore, UL synchronization mechanisms for IoT devices/tags cannot rely on SS transmitted in the DL, and an alternative approach is required for achieving reliable UL communication.

Given the aforementioned challenges and limitations of IoT devices/tags operating in a cellular communication environment, this disclosure proposes a frequency and timing synchronization method in which downlink (DL) and uplink (UL) synchronization mechanisms are separated and independently operated.

In details, the synchronization of an IoT device/tag's carrier frequency and timing in the DL for receiving transmissions from the BS is distinct from the synchronization used for UL transmissions in response to the BS. These separate synchronization mechanisms for DL and UL rely on different synchronization signals (SS) provided by different source nodes. In other words, the method by which an IoT device/tag acquires frequency and timing synchronization for receiving DL transmissions from the BS is independent and unassociated with the mechanism used for UL synchronization when transmitting to the BS.

### Proposed Initiation-Based Device/Tag Synchronization in IoT DL Communication

As previously detailed, a battery-less IoT device/tag operates solely on ambient energy harvested from RF signals within the frequency spectrum it is designed to function. For instance, if an IoT device/tag is tuned to receive downlink (DL) signals or perform uplink (UL) backscattering in a specific frequency band (e.g., the 900 MHz RF band), it can harvest ambient RF energy from signals transmitted in that spectrum. This harvested energy may be stored for later use or immediately used to power the device/tag for receiving DL transmissions from the BS and/or transmitting UL signals to the BS.

As a common law of radio propagation, all radiated RF signal energy degrades/fades with the propagation distance (a.k.a. pathloss) and material penetration/blocking loss (e.g., signals going through a wall). As such, the longer the distance separation between a BS and an IoT device/tag, lesser the ambient energy can be harvested by the device/tag. Typically, the energy/power required to decode DL signals for receiving information from the BS is far less than the total energy/power required to transmit in the UL to the BS, as the UL transmission process involves not only the encoding of data information but also the actual radiation/transmission of RF signals in a UL carrier (i.e., signal amplification).

To power an IoT device/tag, one approach could be using/deploying a wireless power supply/transfer node or a carrier wave node (CWN) to constantly transmit RF signals with high power (if the desired coverage range is large) in the intended operation frequency spectrum of the device/tag, such that the device/tag is always powered ON and ready to receive from the BS in the DL at any time). However, as detailed earlier, this is not an environmentally friendly and cost-effective approach, since the IoT communication from the BS could be very infrequent. Since the required IoT device/tag processing power of DL signals from the BS is not expected to be high, it is proposed that the SS transmitted by the BS is primarily used for 2 main purposes/functions in IoT DL communication.
1. Provide wireless energy/charging to power-ON IoT devices/tags in order to synchronize and process DL transmissions from the BS.
2. Provide a source of reference to IoT devices/tags for frequence and timing synchronization of a DL carrier.

The process of acquiring/achieving frequency and timing synchronization of a DL carrier by an IoT device/tag could be considered/organized into 3 stages.

Stage 1 (energy harvesting/power-ON): As detailed earlier, an IoT device/tag needs to first “power-ON” have sufficient energy stored before it is able to process SS transmitted by the BS and perform a DL synchronization procedure. When an IoT device/tag already has sufficient energy in the storage, this stage can be obviously omitted and proceed to the next stage (Stage 2 or Stage 3). When an IoT device/tag does not have sufficient energy in the storage, it relies on the SS transmitted in the DL carrier from the BS to “charge obtain” energy prior to performing the DL synchronization procedure. In order to “charge/power-ON” an IoT device/tag for DL synchronization, the SS could be transmitted by the BS using one or a combination of the following methods.
(1) BS transmits SS periodically with a pre-fined or pre-configured time interval. Each periodically transmitted SS provides ambient power to the IoT device/tag for energy storage. Once the IoT device/tag has a sufficient energy in the storage, it utilizes subsequent SS transmissions from the BS to perform the DL synchronization procedure (e.g., initial/coarse synchronization in Stage 2).
(2) BS transmits one or more SS within a pre-defined or pre-configured time window just before a data and/or control signaling transmission to the device/tag (e.g., data is carried in a physical downlink shared channel (PDSCH), control is carried in a physical downlink control channel (PDCCH)). The SS provided in the time window can be transmitted with a short time gap or forming a back-to-back transmission (e.g., in consecutive multiple DL symbols) to allow rapid charging of the IoT device/tag. The intention of this rapid charging just prior to a data/control transmission is not only for the device/tag to perform the DL synchronization procedure, but also to provide sufficient energy to the device/tag for processing/decoding of the data/control transmission. Similar to the above method 1, once the IoT device/tag has a sufficient energy in the storage from the rapid charging, it utilizes subsequent SS transmissions within the time window from the BS to perform the DL synchronization procedure (e.g., synchronization fine tuning in Stage 3).

As can be seen from the above description, the proposed Stage 1 provides an initiation phase for an IoT device/tag to wake-up/power-ON and perform a DL synchronization procedure to receive IoT communication from a BS.

Stage 2 (initial/coarse DL synchronization): When an IoT device/tag is charged or has sufficient energy in the storage, the device/tag can perform a DL synchronization procedure in attempt to detect a DL carrier or channel within a pre-defined IoT frequency spectrum band in order to receive any data or control signaling information from the BS. As mentioned earlier SS may not be constantly transmitted, but once the device/tag is charged by one or more SS transmitted in a DL carrier, the device/tag can be able to detect the subsequent SS transmitted from the BS.

In Method 1 of Stage 1, when the synchronization signal (SS) is transmitted periodically, its primary purpose is to supply IoT devices/tags with sufficient energy to detect subsequent SS transmissions and perform downlink (DL) synchronization. However, since a periodically transmitted SS is not necessarily followed immediately by a data or control signaling transmission from the base station (BS), timing drift due to sampling frequency offset/error may occur.

When the time gap between a periodic SS and the actual data/control signaling transmission is large, frequency and timing offsets can become significant. As a result, the synchronization obtained from the periodic SS may no longer be sufficiently precise for an IoT device/tag to reliably receive and decode DL data and control signaling from the BS. Nevertheless, the coarse synchronization provided by the periodic SS still serves an important role—it allows IoT devices/tags to initially tune and track the radio frequency while determining the communication radio frame and slot timing for the actual IoT transmission. This enables Stage 3 (synchronization fine-tuning) to utilize a simpler and shorter preamble design, allowing for a faster and more efficient fine-tuning process to achieve precise frequency and timing synchronization for receiving DL data and signaling from the BS.

Stage 3 (DL synchronization fine-tuning): After an IoT device/tag has achieved an initial/coarse frequency and time synchronization of a DL carrier or channel in Stage 2, for the synchronization fine-tuning just before a reception of DL data and signaling, a preamble sequence with a fixed/pre-defined bit pattern at the beginning of each DL transmission can provide an opportunity for the IoT device/tag to fine tune both the exact DL carrier frequency and radio frame/slot boundaries for IoT communication. Alternatively, or additionally, as detailed in the above Stage 1 method 2, SS used in Stage 1 and 2 could be also utilized in Stage 3 for the charging of IoT devices/tags and DL synchronization fine-tuning.

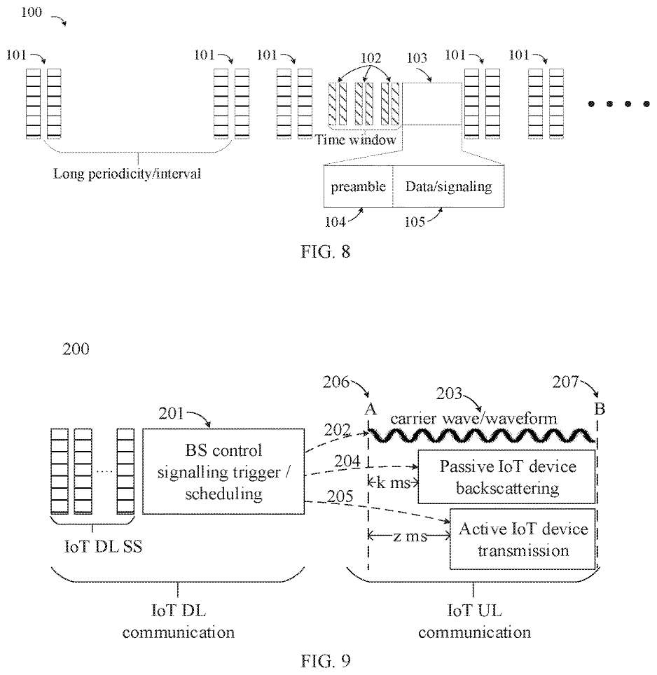

In reference to diagram 100 in FIG. 8, the proposed SS transmission methods in different stages of IoT DL communication is exemplarily illustrated for an IoT device/tag to synchronize in both frequency and time to a DL carrier.

For the 1st stage of IoT DL communication to charge or power-ON an IoT device/tag in order to receive data and signaling information in the downlink, according to the proposed method 1, the BS transmits SS 101 periodically with a pre-fined or pre-configured time interval. Once the device/tag is charged/power-ON, in the 2nd stage of IoT DL communication, it receives other periodic SS 101 from the BS for an initial/coarse frequency and time synchronization to the IoT DL carrier. As the sample frequency offset/error is likely to occur in an IoT device/tag, in the 3rd stage of IoT DL communication, the BS transmits additional SS 101 within a time window 102 or a preamble 104 (or called preamble sequence) for fine-tuning (readjustment) of DL carrier frequency and timing in the IoT device/tag just before a IoT DL data and signaling communication (or called data/signaling 105) from the BS.

Alternatively, in the proposed method 2, the BS transmits a burst of SS within a time window 102 to rapid charge/power-ON the IoT device/tag just before a IoT DL data and signaling communication 103 from the BS. From the transmitted SS burst, the IoT device/tag also performs a DL synchronization procedure to acquire frequency and time synchronization to the DL carrier. In this case, the transmission of a preamble sequence 104 for fine-tuning of DL carrier frequency and time may not be needed from the BS.

In the above, the transmission schemes and timing occasions in which the SS and preamble sequence could be transmitted by the BS (in the time domain) for charging/power-ON and synchronizing IoT devices/tags to a DL carrier for IoT communication are described and proposed.

In the frequency domain, as the band filter design for IoT device/tag receivers is expected to be of a low cost and low complexity, it is very difficult/challenging for the receiver band filter to preciously pass through just the signals that were transmitted by the BS in a narrow bandwidth (e.g., a single IoT channel of just 180 kHz) and filter out all unwanted transmissions in other/adjacent IoT channels. As such, it is likely the passband of the receiver band filter design will cover the entire frequency spectrum allocated for the IoT DL communication (e.g., 900 MHz DL band). In this case, it is proposed that the SS transmitted by the BS follows one of the following allocation schemes in the frequency domain.

Frequency allocation scheme A: The entire (pre-)configured BW portion/part (BWP) of a DL carrier allocated for IoT communication.

When the IoT SS is designed to be of a long sequence, which is beneficial for SS detection, the transmission of the SS in the DL from the BS can cover the entire BWP allocated for IoT communication. Since the BWP of an operating IoT carrier is (pre-)configured, it would be simple and straight forward for an IoT device/tag to perform the correlation function over the entire BWP to detect a transmitted SS from the BS.

Frequency allocation scheme B: Only in a fixed/pre-defined or (pre-)configured frequency location with a pre-defined bandwidth (BW) within the (pre-)configured BWP allocated for IoT DL communication. In this frequency allocation scheme for the IoT SS in the DL: (1) no floating location in the frequency domain is allowed within the (pre-)configured BWP, as it only adds processing complexity and latency to the IoT device/tag in attempting to synchronize to the DL carrier for IoT communication, since it will require the IoT device/tag to perform the signal correlation processes at multiple frequency locations, and (2) a frequency offset value (e.g., in number of resource blocks or channels) could be pre-defined or indicated to the IoT devices/tags in advanced (e.g., by means of configuration) such that some flexibility is allowed in the frequency location of a transmitted SS from the BS.

As for the frequency location of the preamble sequence to be transmitted just before a data and/or signaling delivery in the DL from the BS, the above two frequency allocation schemes A and B equally applies. Additionally, a frequency allocation scheme C could be employed for the preamble sequence transmission as well is that the sequence is transmitted only in the same IoT channel where the subsequent data and/or signaling information is to be transmitted from the BS.

### Proposed Trigger-Based Device/Tag Synchronization for IoT UL Communication

In IoT UL communication, where a battery-less IoT device/tag would need more energy/power than the DL to encode its information data, modulate onto a UL carrier (for backscattering/passive type of devices/tags) or generate an UL frequency carrier by itself (for active type of devices/tags), and amplify the carrier wave for UL transmission to the BS, the ambient energy received and stored from DL transmissions is likely insufficient for these tasks. Also, as detailed earlier, the frequency and radio frame/slot timing conversion from the DL synchronization would be inaccurate and unreliable. Therefore, a different synchronization and device/tag charging mechanisms for the IoT UL communication is necessary.

As mentioned in the background section, a carrier wave node (CWN) is typically used in IoT communication Topology 1 to provide a carrier wave/waveform on a UL frequency carrier for 1) charging IoT devices/tags for UL communication and 2) resolving a full duplex issue where a BS cannot transmit and receive at the same time for devices/tags that perform backscattering on a UL carrier. Since the carrier wave/waveform from a CWN is already providing these functionalities for IoT UL communication, it is proposed in this invention disclosure that frequency and time synchronization for UL transmissions from an IoT device/tag are derived based on the IoT UL channel and the timing from which the carrier wave/waveform is transmitted by the CWN. As such, the carrier wave/waveform transmitted in the IoT UL spectrum by the CWN, which could be a normal UE, is proposed to serve/provide the following functionalities in IoT UL communication.

The transmitted carrier wave/waveform provides a mean (i.e., a carrier) from which a passive type of IoT device/tag performs a backscattering for IoT uplink communication.

The transmitted carrier wave/waveform provides a reference point for frequency and timing synchronization of an active type of IoT device/tag to perform UL transmission on a self-generated carrier (i.e., an UL carrier).

The transmitted carrier wave/waveform provides energy and charges both passive and active types of IoT device/tag at least for IoT UL communication.

Since the transmission frequency channel and timing to be used by an IoT device/tag for an UL communication are fully controlled and scheduled by the BS, it is proposed that the BS can also triggers the CWN to transmit a carrier wave/waveform in an IoT UL frequency channel and at a timing that are able to provide the aforementioned functionalities. The BS triggering or the indication for the CWN to transmit a carrier wave/waveform could be based on one of the following mechanisms.

Mechanism X: Since the CWN and IoT device/tag are all within the signal communication coverage of the BS, this means the BS control and scheduling of an UL transmission from the IoT device/tag (e.g., an UL scheduling information carried in downlink control information (DCI) to the IoT device/tag) would be also readable by the CWN. As such, by this Mechanism X, the CWN reads directly from the UL scheduling information provided to the IoT device/tag, acquires the exact UL frequency channel and timing from which the IoT device/tag needs to perform an UL transmission, and transmits a carrier wave/waveform that includes at least the scheduled UL frequency channel and covers at least the duration of IoT device/tag's UL transmission. For this Mechanism X, the CWN needs to detect and read UL scheduling information from the BS (e.g., in multiple DCIs) for all the IoT devices/tags.

Mechanism Y: Alternatively, the BS directly triggers the CWN by indicating the exactly UL frequency channel(s) and the timing (i.e., including the duration) to transmit one or more carrier waves/waveforms. The trigger/indication could be carried for example in a DCI to the CWN and includes information such as one or more UL frequency channels, start timing and transmission duration of a carrier wave/waveform.

In both Mechanism X and Mechanism Y, in order to ensure there is sufficient energy stored and available for the scheduled UL communication from the IoT device/tag, the actual timing to transmit a carrier wave/waveform from the CWN can be earlier than the scheduled UL transmission for the IoT device/tag. For example, in Mechanism X, the CWN determines a start timing for the carrier wave/waveform transmission that is earlier than a scheduled IoT UL transmission based on a timing offset which could be a fixed/pre-defined or (pre-)configured value (e.g., k ms or slots). In Mechanism Y, the starting timing indicated by the BS could already include the timing offset. At the IoT device/tag, since a rough timing synchronization is already acquired from the initial/coarse DL synchronization when it received the SS in the DL from the BS, once the carrier wave/waveform is detected/received from the CWN and the timing offset is known, the device/tag would be able to derive the exact communication radio frame/slot timing boundaries for its IoT UL transmission. Hence, the UL time synchronization is achieved. Alternatively, or additionally, one could further enforce the start time of a carrier wave/waveform transmission is always from a communication radio frame/slot boundary. Then based on this property, the IoT device/tag performs its UL time synchronization to the carrier wave/waveform provided by the CWN.

Then by receiving a carrier wave/waveform transmitted from the CWN just before an IoT device/tag's scheduled UL transmission, a passive type of IoT device/tag modulates its data information on to the carrier wave/waveform and performs backscattering transmission at a timing scheduled by the BS. Thus, achieving the frequency synchronization to the UL carrier for the IoT UL communication.

For an active type of IoT device/tag, the device/tag generate a UL carrier for the IoT UL communication according to the frequency channel(s) in which the carrier wave/waveform is received. Thus, achieving the frequency synchronization.

As described in both mechanisms X and Y, since the exact frequency channel(s) and the timing of a carrier wave/waveform transmission is fully triggered/controlled by the BS, there would be no excess carrier wave/waveform transmission in a frequency channel and at a time duration that are unnecessary for IoT devices/tags to perform IoT UL communication. Hence, by using either one of these two proposed mechanisms, it will create no resource wastage in the UL and unwanted interference to the normal cellular UL operation in the same cell or to the neighbor cell/carrier, as compared to a scheme where a carrier wave/waveform is always transmitted by the CWN.

In reference to diagram 200 in FIG. 9, the proposed trigger-based UL frequency and timing synchronization mechanisms are illustrated for different types of IoT devices/tags. Since IoT communication in the uplink from an IoT device/tag is always controlled by the BS, the BS first transmits its control signaling (or called BS control signalling trigger/scheduling 201) as part of IoT DL communication to schedule one or multiple IoT devices/tags from a certain timing(s) as shown by 204 for a passive IoT device/tag to perform a backscattering transmission and as shown by 205 for an active IoT device/tag to transmit on a UL carrier. At the same time, the BS also sends a control signaling to trigger a CWN in 202 or a CWN self-monitored/detected one or more scheduled UL transmissions 204 or 205 and determined to transmit a carrier wave/waveform 203 starting from a time point A 206 until a time point B 207 which covers at least the entire duration of the backscattering transmission from the passive device/tag. The transmitted carrier wave/waveform in one or multiple IoT UL channels can be used by both passive and active devices/tags to acquire UL frequency synchronization.

In case of Mechanism X is used by the CWN, the time point A 206 to transmit the carrier wave/waveform 203 is determined by the CWN based on a pre-defined or (pre-)configured timing offset of k ms or slots, especially for the passive IoT device/tag. For the active IoT device/tag's UL transmission, since the time gap between time point A 206 and the start of the scheduled UL transmission is z ms or slots (which is greater than the timing offset of x ms or slots), the active IoT device/tag acquires UL synchronization based on the radio frame/slot boundary from which the carrier wave/waveform is transmitted and determines its UL transmission start time accordingly.

In the case when Mechanism Y is used, where the BS directly indicates to the CWN the starting time and duration to transmit the carrier wave/waveform, the passive and active IoT devices/tags determine their UL transmission starting times in the same manner as in Mechanism X according to the timing offset (x ms or slots) and the radio frame/slot boundary, respectively.

In summary, some embodiments propose methods for frequency and time synchronization of IoT devices/tags in both downlink (DL) and uplink (UL) communications within a cellular system. For DL synchronization, the base station (BS) periodically transmits synchronization signals to provide energy for powering on the IoT device/tag and enabling initial/coarse synchronization to the DL carrier. Just before data and signaling delivery, the BS transmits a burst of synchronization signals or a preamble sequence within a pre-configured time window for fine-tuning synchronization. The frequency allocation of these synchronization signals follows predefined schemes (A, B, or C) to enhance flexibility and efficiency. For UL synchronization, since IoT devices/tags, especially passive ones, require more power for encoding and transmission, ambient energy harvested from DL signals may be insufficient. To address this, a carrier wave node (CWN) transmits a carrier wave/waveform in the UL frequency channel and timing as triggered by the BS. Two mechanisms are proposed: (1) Mechanism X, where the CWN derives the UL frequency and timing from the BS-scheduled UL transmission for the IoT device/tag; and (2) Mechanism Y, where the BS explicitly indicates the UL frequency and timing to the CWN. In both cases, the CWN starts transmission ahead of the scheduled UL time to ensure sufficient energy availability and synchronization. The IoT device/tag achieves precise UL time synchronization by detecting the CWN-provided carrier wave/waveform, considering a known timing offset. Passive IoT devices/tags utilize this carrier wave for backscattering, while active devices/tags generate their UL carrier based on the received frequency channel. These proposed mechanisms enable efficient synchronization and power management for IoT devices/tags, ensuring reliable communication in both DL and UL.

Commercial interests for some embodiments are as follows. 1. Solving issues in the prior art and other issues. 2. Improving a communication performance. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 19, and beyond for providing IoT wireless communication services.

FIG. 10 is a block diagram of an example of a computing device according to an embodiment of the present disclosure. Any suitable computing device can be used for performing the operations described herein. For example, FIG. 10 illustrates an example of the computing device 1100 that can implement some embodiments in FIG. 1 to FIG. 9, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 9. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

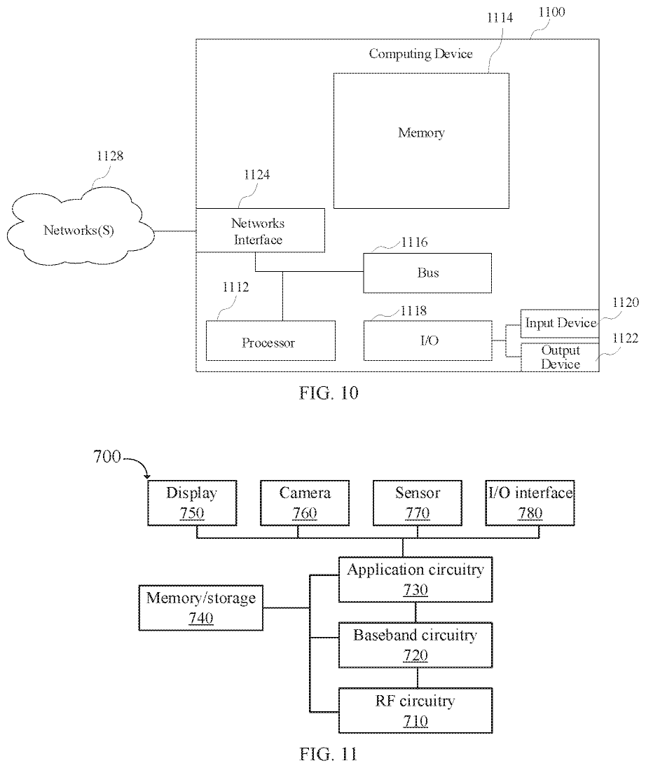

FIG. 11 is a block diagram of an example system 700 for wireless communication according to an embodiment of the present disclosure. Embodiments described herein may be implemented into the system using any suitably configured hardware and/or software. FIG. 11 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes may not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A synchronization method for Internet of Things (IoT) communication performed by a base station, comprising:
transmitting at least one of a synchronization signal (SS) and a preamble to be used by an IoT device for clock timing synchronization and receiving an IoT downlink (DL) communication, wherein the SS is transmitted periodically with a time interval or the SS is transmitted one or multiple times within a time window, and the preamble with a sequence pattern is transmitted prior to a DL transmission.

2. The method of claim 1, wherein the time interval is pre-defined or pre-configured.

3. The method of claim 1, wherein the time window is pre-defined or pre-configured.

4. The method of claim 1, wherein the sequence pattern is a fixed or pre-defined sequence pattern.

5. The method of claim 1, further comprising:
transmitting the at least one of the SS and the preamble periodically in a DL carrier prior to the DL transmission.

6. The method of claim 1, wherein the at least one of the SS and the preamble is transmitted in a frequency location with a bandwidth (BW) that covers an entire bandwidth part (BWP) of a DL carrier allocated for IoT communication.

7. The method of claim 1, wherein the at least one of the SS and the preamble is transmitted in a frequency location with a bandwidth (BW) within a BWP allocated for IoT DL communication;
wherein a frequency offset value is pre-defined or indicated to the IoT device.

8. The method of claim 1, wherein the at least one of the SS and the preamble is transmitted in the same IoT channel where the DL transmission is to be transmitted from the base station.

9. A base station, comprising:
a memory;
a transceiver; and
a processor coupled to the memory and the transceiver;
wherein the base station is configured to perform:
transmitting at least one of a synchronization signal (SS) and a preamble to be used by an IoT device for clock timing synchronization and receiving an IoT downlink (DL) communication, wherein the SS is transmitted periodically with a time interval or the SS is transmitted one or multiple times within a time window, and the preamble with a sequence pattern is transmitted prior to a DL transmission.

10. The base station of claim 9, wherein the time interval is pre-defined or pre-configured.

11. The base station of claim 9, wherein the time window is pre-defined or pre-configured.

12. The base station of claim 9, wherein the sequence pattern is a fixed or pre-defined sequence pattern.

13. An Internet of Things (IoT) device, comprising:
a memory;
a transceiver; and
a processor coupled to the memory and the transceiver;
wherein the IoT device is configured to perform:
receiving at least one of a synchronization signal (SS) and a preamble for clock timing synchronization and receiving an IoT downlink (DL) communication, wherein the SS is transmitted periodically with a time interval or the SS is transmitted one or multiple times within a time window, and the preamble with a sequence pattern is transmitted prior to a DL transmission.

14. The IoT device of claim 13, wherein the time interval is pre-defined or pre-configured.

15. The IoT device of claim 13, wherein the time window is pre-defined or pre-configured.

16. The IoT device of claim 13, wherein the sequence pattern is a fixed or pre-defined sequence pattern.

17. The IoT device of claim 13, wherein the IoT device is configured to further perform:
receiving the at least one of the SS and the preamble periodically in a DL carrier prior to the DL transmission.

18. The IoT device of claim 13, wherein the at least one of the SS and the preamble is transmitted in a frequency location with a bandwidth (BW) that covers an entire bandwidth part (BWP) of a DL carrier allocated for IoT communication.

19. The IoT device of claim 13, wherein the at least one of the SS and the preamble is transmitted in a frequency location with a bandwidth (BW) within a BWP allocated for IoT DL communication; wherein a frequency offset value is pre-defined or indicated to the IoT device.

20. The IoT device of claim 13, wherein the at least one of the SS and the preamble is transmitted in the same IoT channel where the DL transmission is to be transmitted from a base station.
